(19) United States
(12) Patent Application Publication
(10) Pub. No.: US 2009/0024435 A1
(43) Pub. Date: Jan. 22, 2009

(54) Methods, Systems, and Computer-Readable Media for Providing Notification of a Last Job Dispatch

(76) Inventors: Robert Ingman, Peachtree City, GA (US); Robert Cole, Birmingham, AL (US); Richard Miller, Hoover, AL (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/778,867

(22) Filed: Jul. 17, 2007

(51) Int. Cl. G06Q 10/00

(52) U.S. Cl. 705/9; 718/100

(57) ABSTRACT

Methods, systems, and computer-readable media provide a notification of a last job dispatch. According to embodiments, a method for providing a notification of a last job dispatch is provided. According to the method, whether a technician is dispatched to a last job is determined. In response to determining that the technician is dispatched to the last job, a visual cue indicating that the technician is dispatched to the last job is provided.

### CROSS-REFERENCE TO RELATED APPLICATIONS

The present application is related to commonly assigned U.S. patent application Ser. No. ______, filed concurrently herewith, titled “METHODS, SYSTEMS, AND COMPUTER-READABLE MEDIA FOR DETERMINING A PLURALITY OF TURFS FROM WHERE TO REALLOCATE A WORKFORCE TO A GIVEN TURF,” with attorney docket number 070003; commonly assigned U.S. patent application Ser. No. ______, filed concurrently herewith, titled “METHODS, SYSTEMS, AND COMPUTER-READABLE MEDIA FOR GENERATING A REPORT INDICATING JOB AVAILABILITY,” with attorney docket number 070004; commonly assigned U.S. patent application Ser. No. ______, filed concurrently herewith, titled “METHODS, SYSTEMS, AND COMPUTER-READABLE MEDIA FOR PROVIDING AN INDICATION OF A SCHEDULE CONFLICT,” with attorney docket number 070005; commonly assigned U.S. patent application Ser. No. ______, filed concurrently herewith, titled “METHODS, SYSTEMS, AND COMPUTER-READABLE MEDIA FOR PROVIDING AN INDICATION OF HIGHTIME,” with attorney docket number 070006; commonly assigned U.S. patent application Ser. No. ______, filed concurrently herewith, titled “METHODS, SYSTEMS, AND COMPUTER-READABLE MEDIA FOR PROVIDING FUTURE JOB INFORMATION,” with attorney docket number 070007; commonly assigned U.S. patent application Ser. No. ______, filed concurrently herewith, titled “METHODS, SYSTEMS, AND COMPUTER-READABLE MEDIA FOR PROVIDING COMMITMENTS INFORMATION RELATIVE TO A TURF,” with attorney docket number 070009; commonly assigned U.S. patent application Ser. No. ______, filed concurrently herewith, titled “METHODS, SYSTEMS, AND COMPUTER-READABLE MEDIA FOR PROVIDING CONTACT INFORMATION AT TURF LEVEL,” with attorney docket number 070010; commonly assigned U.S. patent application Ser. No. ______, filed concurrently herewith, titled “METHODS, SYSTEMS, AND COMPUTER-READABLE MEDIA FOR PROVIDING A RATIO OF TASKS PER TECHNICIAN,” with attorney docket number 070011; and commonly assigned U.S. patent application Ser. No. ______, filed concurrently herewith, titled “METHODS, SYSTEMS, AND COMPUTER-READABLE MEDIA FOR PROVIDING WORKFORCE TO LOAD INFORMATION,” with attorney docket number 060482; each of which is hereby incorporated herein by reference.

### TECHNICAL FIELD

This application relates generally to the field of load balancing. More specifically, the disclosure provided herein relates to the field of dynamic workforce reallocation.

### BACKGROUND

Telecommunications networks may provide a number of services, such as plain old telephone service (“POTS”), digital subscriber line (“DSL”), and cable. Maintenance of the telecommunications network generally involves the assignment of an appropriate technician to each outstanding job such that all of the outstanding jobs are timely filled. When a technician finishes one job and is ready to be dispatched to another job, the technician may receive next job information. The next job information may include, for example, the location of the next job and the type of work to be done in the next job. The technician may receive the next job information via a portable computing device, such as a laptop computer, which enables the technician to receive the job information out in the field without having to return to a base station.

A sufficient number of technicians are typically hired to comfortably fill an estimated number of jobs. There may be times, however, when the availability of technicians is greater than the availability of jobs for which the available technicians are qualified. In such a case, instead of receiving next job information on the portable computing device when the technician is ready to be dispatched to another job, the technician will receive a No Jobs Available (“NJA”) message. The NJA message may be transmitted to the technician from a load balance personal computer (“PC”) responsible for dispatching technicians to jobs.

A load balance supervisor (“LBS”), utilizing the load balance PC, is generally responsible for dispatching work to a plurality of technicians. When a technician is dispatched to a last job (i.e., next job information is not available), the LBS may be unaware that the technician is being dispatched to the last job. After the technician completes the last job and receives the NJA message, the technician conventionally contacts (e.g., by telephone) the LBS to notify the LBS that the technician has completed the last job and to request more work. Having to manually contact the LBS each time the technician receives the NJA message is potentially time-consuming and inefficient. Further, since the technician is typically not contacting the LBS until after the technician receives the NJA message, significant time may be lost from the time at which the technician receives the NJA message to the time at which the LBS dispatches the technician to the next job.

One conventional solution, known as stacking, involves populating the technician's work list (i.e., a schedule of jobs for a given time period, such as a day) with more jobs than the technician is capable of completing. Stacking may be performed as part of a bulk load, whereby a specified number of jobs are assigned (i.e., locked) to the technician. Stacking, however, may increase the likelihood of missed customer appointments because the technician may not be able to complete every assigned job. Further, stacking may increase the workload on the LBS, especially in the latter part of the technician's work shift, because the LBS may need to reassign the jobs that the technician cannot complete.

### SUMMARY

Embodiments of the disclosure presented herein include methods, systems, and computer-readable media for providing a notification of a last job dispatch. According to one aspect, a method for providing a notification of a last job dispatch is provided. According to the method, whether a technician is dispatched to a last job is determined. In response to determining that the technician is dispatched to the last job, a visual cue indicating that the technician is dispatched to the last job is provided.

According to another aspect, a system for providing a notification of a last job dispatch is provided. The system includes a memory and a processor functionally coupled to the memory. The memory stores a program containing code for providing a notification of a last job dispatch. The processor is responsive to computer-executable instructions contained in the program and operative to determine whether a technician is dispatched to a last job, and in response to determining that the technician is dispatched to the last job, provide a visual cue indicating that the technician is dispatched to the last job.

According to yet another aspect, a computer-readable medium having instructions stored thereon for execution by a processor to perform a method for providing a notification of a last job dispatch. According to the method, whether a technician is dispatched to a last job is determined. In response to determining that the technician is dispatched to the last job, a visual cue indicating that the technician is dispatched to the last job is provided.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a diagram of an exemplary embodiment of a graphical user interface (“GUI”) in a previous version.

FIG. 2 is a high-level diagram illustrating an allocation of technicians for maintaining and repairing a telecommunications network, in accordance with exemplary embodiments.

FIG. 3 a block diagram illustrating a computer configured to provide notification of a last dispatch, in accordance with exemplary embodiments.

FIG. 4 is a block diagram of a workforce reallocation system, in accordance with exemplary embodiments.

FIG. 5 is a diagram illustrating a GUI, in accordance with exemplary embodiments.

FIG. 6 is a flow diagram illustrating a method for providing notification of a last job, in accordance with exemplary embodiments.

### DETAILED DESCRIPTION

The following detailed description is directed to methods, systems, and computer-readable media for notifying a central office of a last dispatch. In the following detailed description, references are made to the accompanying drawings that form a part hereof, and which are shown by way of illustration specific embodiments or examples.

As used herein, the terms “work order,” “job,” and “task” are used interchangeably. Although not so limited, embodiments described herein primarily refer to a “work order” as the maintenance and repair of a telecommunications network by a technician. However, it will be apparent to one of ordinary skill in the art that, in further embodiments, a “work order” may include any suitable service that involves the allocation and reallocation of personnel to perform the service. As used herein, a technician refers to any suitable personnel for performing a service.

Embodiments described herein provide a Next Generation Load Balance (“NGLB”) tool for work force reallocation. According to exemplary embodiments, the NGLB tool has a graphical user interface (“GUI”) containing an organized overview of work order and technician statuses within a plurality of turfs. The NGLB tool may be utilized by a load balance supervisor (“LBS”) or other load balancing personnel to aid in the coordination of work force reallocation within the plurality of turfs. In one embodiment, the NGLB tool is provided to the LBS as a web-based application that can be accessed remotely via, for example, a web browser.

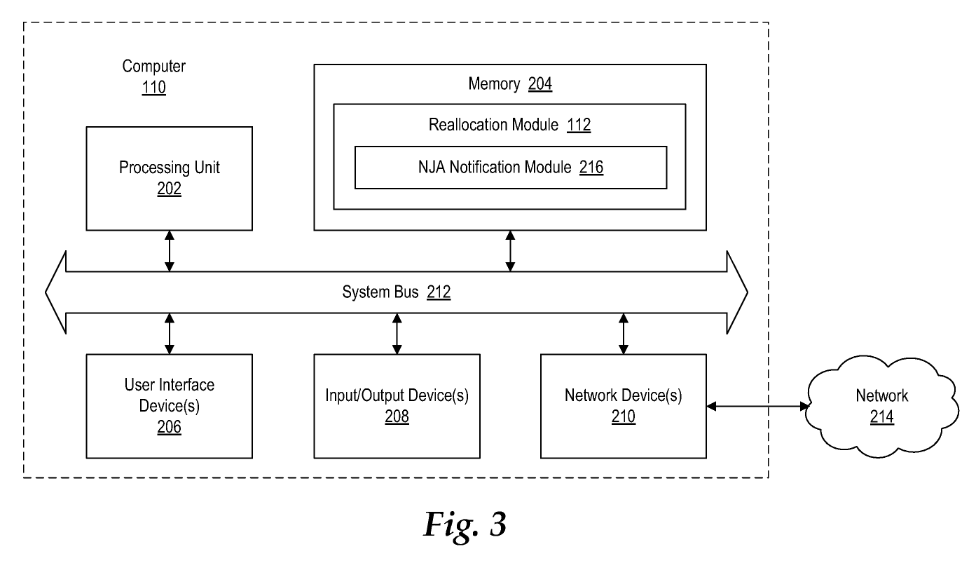

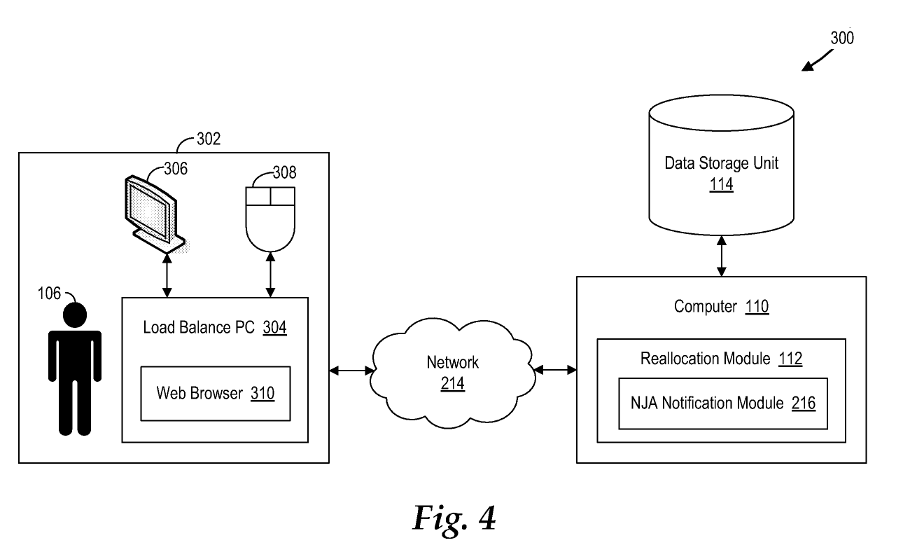

According to further embodiments, the NGLB tool includes a No Jobs Available (“NJA”) notification module, such as a NJA notification module 216 of FIGS. 3 and 4. The NJA notification module 216 is configured to notify the LBS that a technician has been assigned to a last job. In response to the notification that the technician is on the last job, the LBS may take action to prevent the technician from receiving a NJA message when requesting a next job after completing the last job. For example, the LBS may append additional skills to the skill set of the technician such that the technician is eligible for more jobs in a job pool. If the LBS is able to timely take action, then after the technician completes the last job and requests a next job, the technician will receive next job information instead of receiving a NJA message. By receiving the new job instead of the NJA message, the technician may spend more productive time completing dispatched jobs, rather than spending unproductive time contacting the LBS to request the next job.

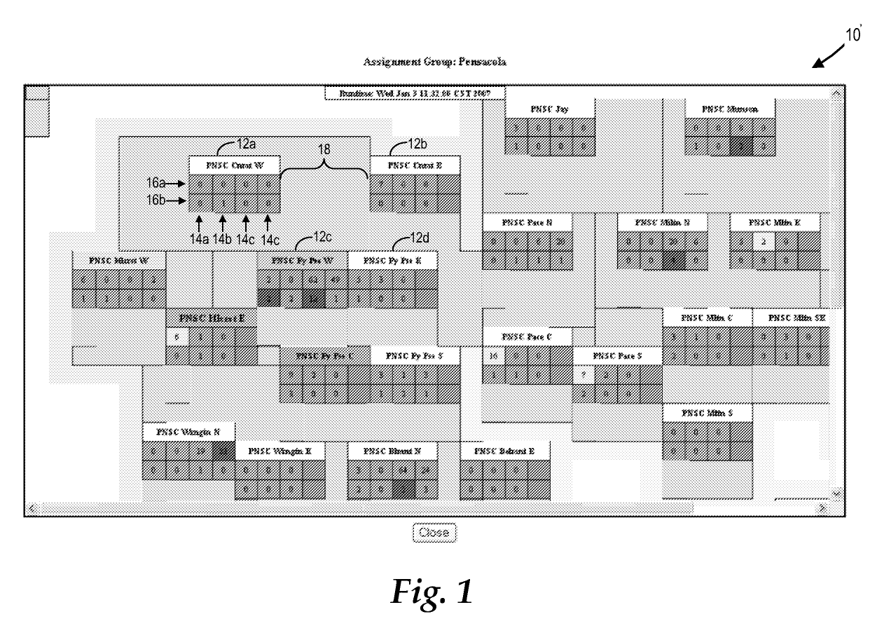

Referring now to the drawings, it is to be understood that like numerals represent like elements through the several figures, and that not all components and/or steps described and illustrated with reference to the figures are required for all embodiments. FIG. 1 is an exemplary embodiment of the GUI 10 utilized in a previous version of the NGLB tool implemented by assignee of this application on or about April 2005. As illustrated in FIG. 1, the GUI 10 includes a plurality of turfs, such as turfs 12a, 12b, 12c, 12d. Each of the turfs, such as the turf 12a, includes four columns 14a, 14b, 14c, 14d. Each of the four columns 14a, 14b, 14c, 14d includes a first cell 16a and a second cell 16b. The first cell 16a includes job information and the second cell 16b includes technician information, according to one embodiment. The GUI 10 provides map presentation of the turfs 12a, 12b, 12c, 12d. The map presentation provides a visual mapping of physical distances between each of the plurality of the turfs 12a, 12b, 12c, 12d. In one example, the physical distance between the turf 12a and the turf 12b is a distance 18. In another example, the turf 12c and turf 12d are contiguous as indicated by the turf 12c being in contact with the turf 12d in the GUI 10.

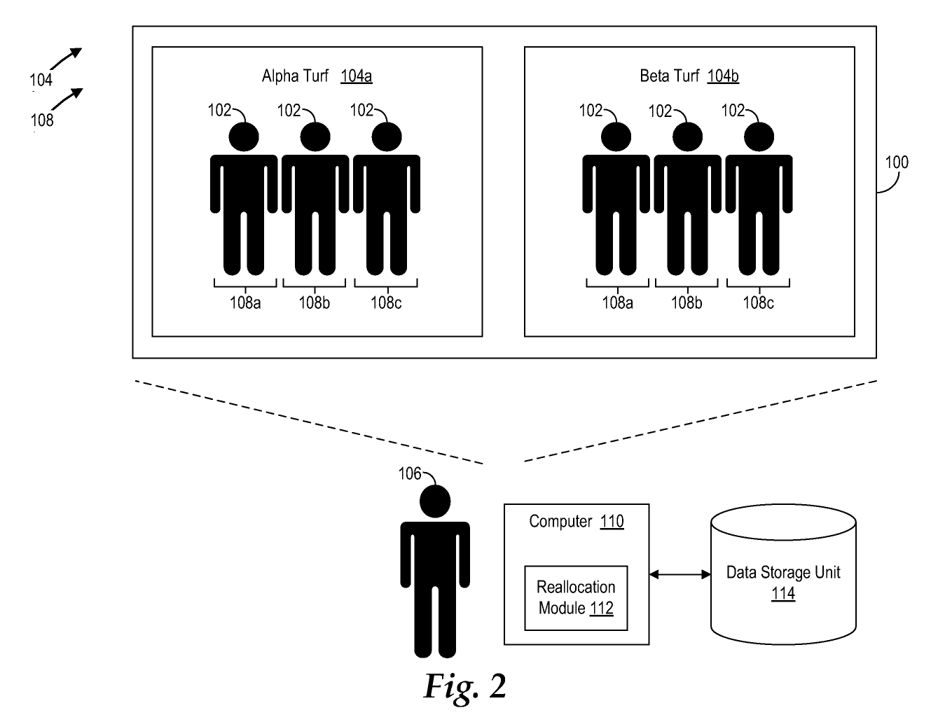

FIGS. 2-6 as described below illustrate a current version of the NGLB tool. FIG. 2 is a high-level diagram illustrating an allocation of the technicians 102 for maintaining and repairing a telecommunications network 100, in accordance with exemplary embodiments. The telecommunications network 100 is maintained and repaired by a plurality of the technicians 102. As illustrated in FIG. 2, each of the technicians 102 is assigned to an Alpha turf 104a or a Beta turf 104b (collectively turfs 104) by a LBS 106 or other load balancing personnel, according to exemplary embodiments. Each turf 104 includes a plain old telephone service (“POTS”) bucket 108a, a digital subscriber line (“DSL”) bucket 108b, and a cable bucket 108c (collectively buckets 108), according to one embodiment. Each of the buckets 108 represents a discipline in which one or more of the technicians 102 may be assigned based on the skill set of the technician 102. In particular, the technician 102 in the POTS bucket 108a should have a skill set for completing POTS related work orders. The technician 102 in the DSL bucket 108b should have a skill set for completing DSL related work orders, and the technician 102 in the cable bucket 108c should have a skill set for completing cable related work orders. In one embodiment, one or more of the technicians 102 may include multiple skill sets for completing work orders under multiple buckets 108. The technicians 102 may be managed by one or more field supervisors (not shown). For example, the technicians 102 in each bucket 108 may be managed by a separate field supervisor.

For the sake of simplicity and without limitation, only two turfs 104a and 104b and three buckets 108a, 108b, and 108c are illustrated in FIG. 2. However, it will be apparent to those of ordinary skill in the art that the telecommunications network 100 may include any suitable number of turfs 104 and any suitable number and types of buckets 108, according to further embodiments.

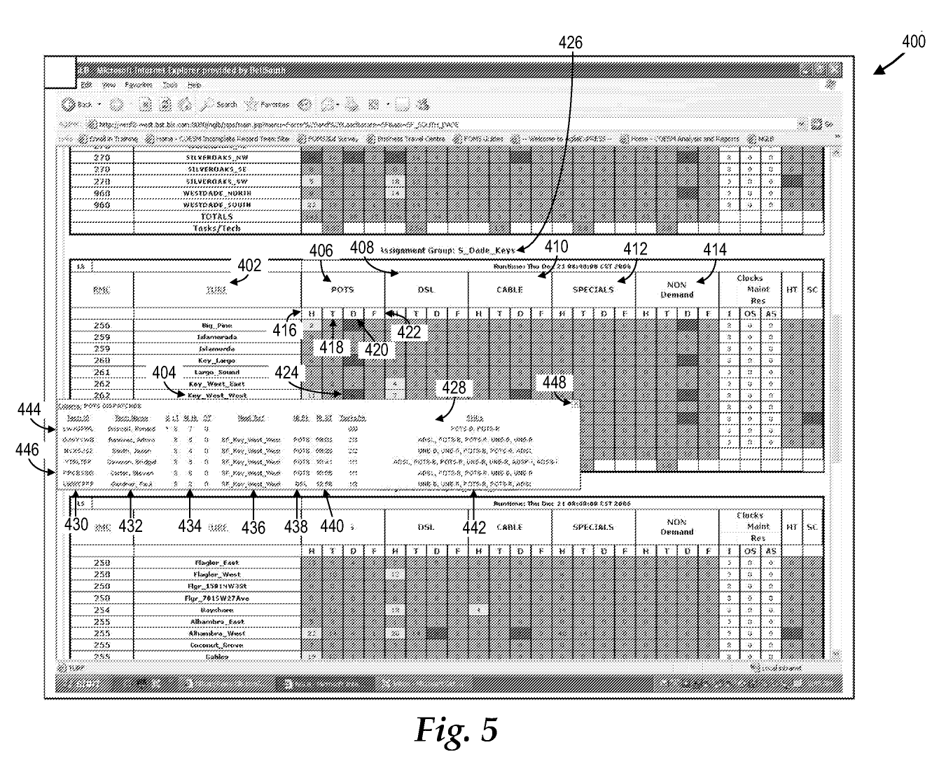

The LBS 106 utilizes a computer 110 to aid in reallocating the plurality of technicians 102 across the turfs 104. The computer 110 includes a reallocation module 112, which enables the computer 110 to display a graphical user interface (“GUI”), such as the GUI 400 of FIG. 5, that provides the LBS 106 with an organized, visual presentation of the technicians 102, the turfs 104, and the buckets 108, according to one embodiment. In one example, if work orders in the Alpha turf 104a cannot be timely filled without additional technicians 102, the LBS 106 may view the GUI 400 to determine if the technicians 102 in the Beta turf 104b can be utilized. In a further example, if service orders in the POTS bucket 108a cannot be timely filled without additional technicians 102, the LBS 106 may view the GUI 400 to determine if the technicians 102 in the DSL bucket 108b or the cable bucket 108c are qualified to fill POTS work orders. In one embodiment, the computer 110 functions as a web server located remotely from the LBS 106 by executing a web server application, such as BEA WEBLOGIC SERVER from BEA SYSTEMS. In this embodiment, the LBS 106 may access the GUI 400 over a network, such as a network 214 of FIGS. 3 and 4, using, for example, a local web browser interface on a personal computer (“PC”) or other computing device.

In one embodiment, the reallocation module 112 generates at least a portion of the GUI 400 based on data stored in a data storage unit 114. The data storage unit 114 may store any suitable data related to the technicians 102, such as the location, skills, schedule, and availability of the technicians 102. The data storage unit 114 may be a database. In one embodiment, the data storage unit 114 is an Integrated Dispatch System (“IDS”). The IDS is described in greater detail in U.S. Patent Application Publication No. 2004/0111311, entitled “Turfs and Skills for Multiple Technicians,” to Ingman et al.; U.S. Patent Application Publication No. 2004/0111312, entitled “Validating Turfs for Work Orders,” to Ingman et al.; U.S. Patent Application Publication No. 2004/0111313, entitled “Methods and Systems for Assigning Multiple Tasks,” to Ingman et al.; and U.S. Patent Application Publication No. 2004/0111634, entitled “Security Permissions for an Integrated Dispatch System,” to Ingman et al.

FIG. 3 and the following discussion are intended to provide a brief, general description of the computer 110 in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 3 is a block diagram illustrating the computer 110 configured to provide notification of a last dispatch, in accordance with exemplary embodiments. The computer 110 includes a processing unit 202, a memory 204, one or more user interface devices 206, one or more input/output (“I/O”) devices 208, and one or more network devices 210, each of which is operatively connected to a system bus 212. The bus 212 enables bi-directional communication between the processing unit 202, the memory 204, the user interface devices 206, the I/O devices 208, and the network devices 210.

The processing unit 202 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 204 communicates with the processing unit 202 via the system bus 212. In one embodiment, the memory 204 is operatively connected to a memory controller (not shown) that enables communication with the processing unit 202 via the system bus 212. According to exemplary embodiments, the memory 204 includes the reallocation module 112. In one embodiment, the reallocation module 112 is embodied in computer-readable media containing instructions that, when executed by the processing unit 202, generates a GUI, such as the GUI 400 of FIG. 5, containing information related to the reallocation of the technicians 102 across a plurality of the turfs 104, as described in greater detail below. Exemplary information related to the reallocation across a plurality of the turfs 104 includes, but is not limited to, the physical proximity between the technicians 102, the availability of the technicians 102, the physical proximity between the turfs 104, the existing load on each of the turfs 104, and the anticipated load on each of the turfs 104. According to further embodiments, the reallocation module 112 may be embodied in hardware, software, firmware, or any combination thereof.

As illustrated in FIG. 3, the reallocation module 112 includes the NJA notification module 216. In one embodiment, the NJA notification module 216 is embodied in computer-readable media containing instructions that, when executed by the processing unit 202, provides notification of a last job dispatch, as described in greater detail below. As used herein, a last job refers to a job in which, after the technician 102 completes the job, the technician 102 will receive a NJA message when requesting a next job. The notification may be provided to the LBS 106 in response to the technician 102 receiving instructions to be dispatched to the last job over a portable computing device (not shown), such as a laptop computer. In one embodiment, the NJA notification module 216 provides the notification to the LBS 106 only if the technician 102 has at least a specified amount of available time, such as thirty minutes, left in the work shift of the technician 102. The amount of available time may be determined by subtracting an estimated completion time of the last job (i.e., the current job of the technician 102) from the amount of time left until the work shift of the technician 102 ends. According to further embodiments, the NJA notification module 216 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 110.

The user interface devices 206 may include one or more devices with which a user accesses the computer 110. The user interface devices 206 may include, but are not limited to, computers, servers, personal digital assistants, cellular phones, or any suitable computing devices. In one embodiment, the computer 110 functions as a web server located remotely from the LBS 106 by executing a web server application, such as BEA WEBLOGIC SERVER from BEA SYSTEMS. By enabling the computer 110 to function as a web server, the LBS 106 may access the GUI 400 generated by the computer 110 over a network, such as the network 214, using, for example, a local web browser interface on a PC or other computing device.

According to exemplary embodiments, the I/O devices 208 enable a user to interface with the reallocation module 112. In one embodiment, the I/O devices 208 are operatively connected to an I/O controller (not shown) that enables communication with the processing unit 202 via the system bus 212. The I/O devices 208 may include one or more input devices, such as, but not limited to, a keyboard, a mouse, and an electronic stylus. Further, the I/O devices 208 may include one or more output devices, such as, but not limited to, a display screen and a printer.

The network devices 210 enable the computer 110 to communicate with other networks or remote systems via the network 214. Examples of the network devices 210 may include, but are not limited to, a modem, a radio frequency (“RF”) or infrared (“IR”) transceiver, a telephonic interface, a bridge, a router, or a network card. The network 214 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 214 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

FIG. 4 is a block diagram of a workforce reallocation system 300, in accordance with exemplary embodiments. The workforce reallocation system 300 includes the computer 110, a network dispatch center (“NDC”) 302, and the data storage unit 114, each of which is operatively connected to the network 214. The NDC 302 includes a load balance PC 304, which is utilized by the LBS 106, according to one embodiment. In further embodiments, the NDC 302 may include any suitable number of load balance PCs 304 to be utilized by any suitable number of LBSs 106. The data storage unit 114 may store any suitable data regarding the technicians 102, such as their location, skills, schedule, and availability. In one embodiment, the reallocation module 112 retrieves data from the data storage unit 114 to generate a GUI, such as the GUI 400 of FIG. 5. The data storage unit 114 may be a database. In one embodiment, the data storage unit 114 is an IDS.

The load balance PC 304 includes a display 306 and a mouse 308, according to one embodiment. In further embodiments, the load balance PC 304 may include any suitable input/output devices 208. It will be apparent to one having ordinary skill in the art that the load balance PC 304 may be substituted with any suitable computing device, such as a personal digital assistant or a cellular phone. The display 306 may be configured to display the GUI 400 generated by the reallocation module 112 and the notification provided by the NJA notification module 216.

In exemplary embodiments, the load balance PC 304 includes a web browser 310, such as INTERNET EXPLORER from MICROSOFT CORPORATION, for accessing the GUI 400 and for facilitating communications between the LBS 106 and the computer 110. Using the web browser 310, the LBS 106 may access the GUI 400 by inputting a Uniform Resource Locator (“URL”) into the web browser 310. The load balance PC 304 may communicate with the computer 110 via Hypertext Transfer Protocol (“HTTP”). As previously described, the computer 110 may function as a web server. In one embodiment, access to the GUI 400 by the load balance PC 304 may be restricted by a login screen requiring, for example, a login identification and a password. In further embodiments, communications between the load balance PC 304 and the computer 110 may be encrypted by any suitable encryption mechanism.

In exemplary embodiments, the computer 110 may communicate with the data storage unit 114 via a Java Database Connectivity (“JDBC”) application program interface (“API”). In one embodiment, the computer 110 retrieves data from the data storage unit 114 at regular intervals, such as every two to five minutes. In further embodiments, the computer 110 retrieves data from the data storage unit 114 when requested by the LBS 106. In other embodiments, the reallocation module 112 may be stored on the load balance PC 304 such that the GUI 400 is accessed from the load balance PC 304 and such that the load balance PC 304 communicates with and retrieves data from the data storage unit 114.

FIG. 5 is a diagram of the GUI 400, in accordance with exemplary embodiments. In one embodiment, the GUI 400 is generated by the reallocation module 112 of the computer 110. The LBS 106 may view the GUI 400 on the display 306 via the web browser 310 associated with the load balance PC 304. In one embodiment, various portions of the GUI 400 are accessible by an input device, such as the mouse 308. It should be appreciated that the GUI 400 illustrated in FIG. 5 is only an exemplary embodiment. It will be apparent to one having ordinary skill in the art that in other embodiments, the GUI 400 may be displayed differently (e.g., as a map presentation), may omit certain fields, or may include other fields.

According to exemplary embodiments, the GUI 400 includes a plurality of turfs 402, such as a west Key West turf 404. The GUI 400 further includes a plurality of buckets: a POTS bucket 406, a DSL bucket 408, a Cable bucket 410, a Specials bucket 412, and a Non-Demand (“ND”) bucket 414. According to exemplary embodiments, each of the buckets 406, 408, 410, 412, 414 includes four columns: an Hours column 416, a Tickets column 418, a Dispatched Technicians (hereinafter referred to as Dispatches) column 420, and a Future Tickets (hereinafter referred to as Futures) column 422. Each of the plurality of cells, such as the cell 424, may be associated with a column, a bucket, and a turf. For example, cell 424 is associated with the Dispatches column 420, the POTS bucket 406, and the west Key West turf 404.

A turf, such as the west Key West turf 404, may refer to any suitable geographic area. For example, the west Key West turf 404 refers to the western portion of the city Key West, Fla. As illustrated in FIG. 5, the GUI 400 displays the turfs 402 contained in the south Dade assignment group (“AG”) 426. In one embodiment, the NDC 302 includes a plurality load balance PCs where each load balance PC corresponds to a different AG, such as the AG 426.

According to exemplary embodiments, the POTS bucket 406 contains information related to POTS related work orders. The DSL bucket 408 contains information related to DSL related work orders. The Cable bucket 410 contains information related cable related work orders. The Specials bucket 412 contains information related to special circuit related work orders, such as Digital Signal 1 (“DS1”) and Digital Signal 3 (“DS3”). The ND bucket 414 is a catch-all bucket containing information related to work orders not categorized in the POTS bucket 406, the DSL bucket 408, the Cable bucket 410, or the Specials bucket 412.

The Hours column 416 indicates the number of hours of pending and assigned work orders in each turf 402, such as the west Key West turf 404. As used herein, an assigned work order is defined as a work order that is assigned to a technician 102, and a pending work order is defined as a work order that is not assigned to a technician, such as the technician 102, and is be completed within the current business day. The Tickets column 418 indicates the number of tickets (i.e., work orders) corresponding to the number of hours shown in the Hours column 416 of one of the buckets 406, 408, 410, 412, 414. The Futures column 422 indicates the number of future jobs to be completed.

The Dispatches column 420 indicates the number of the technicians 102 dispatched. For example, the cell 424 indicates that six technicians 102 are dispatched to perform POTS related work orders in the west Key West turf 404. In one embodiment, each cell, such as the cell 424, in the Dispatches column 420 is highlighted to indicate that at least one of the technicians 102 dispatched is on a last job. For example, the cell 424 may be highlighted or shaded to indicate that at least one of the six technicians 102 dispatched is on a last job. Cells may be highlighted using any suitable visual cue, such as a color.

In one embodiment, at least the highlighted cells in the Dispatches column 420 may be accessed by an input device, such as the mouse 308. For example, the Dispatches column 420 may be accessed by hovering a mouse cursor over a cell, such as the cell 424, or by clicking the cell using the mouse 308. In response to accessing the cell in the Dispatches column 420, the GUI 400 may display a window, such as a drop-down window 428, according to exemplary embodiments.

The drop-down window 428 includes a technician identification (“ID”) column 430, a technician name column 432, an available hours column 434, a next turf column 436, a next bucket column 438, a next start time column 440, and a skills column 442. The technician ID column 430 and the technician name column 432 identify the ID number and name, respectively, of a particular technician, such as the technician 102. For example, at a row 444, the technician ID column 430 is “LWJGFWL,” and the corresponding technician name column 432 is “Driscoll, Ronald.” The available hours column 434 indicates the number of available hours left in the work shift of the technician 102. For example, at the row 444, the available hours column 434 indicates that the technician 102 identified by the technician ID column 430 and the technician name column 432 has seven available hours left in the work shift. The available hours may be determined by subtracting the estimated amount of time left to complete the dispatched job from the number of hours left in the work shift of the technician 102. The available hours may be used by the LBS 106 to determine whether the technician 102 has enough time left in the work shift to complete another job. If the technician 102 does not have enough time left to complete another job, then the LBS 106 may disregard assigning a next job for the technician 102.

The next turf column 436, the next bucket column 438, and the next start time column 440 provide data when the technician 102 is scheduled for a next job (i.e., is not on the last job), according to one embodiment. For example, at a row 446, after the technician 102, “Carter, Steven,” completes the current job, the technician 102 is scheduled to be dispatched to a next job. The next turf column 436 indicates that the next job is in the west Key West turf 404, is in the POTS bucket 406, and is scheduled to start at 10:05 am. In one embodiment, the next turf column 436, the next bucket column 438, and the next start time column 440 are left blank when the technician 102 is not scheduled for a next job (i.e., is on the last job). The blank entries provide the LBS 106 with a quick visual cue indicating which of the technicians 102 is on the last job. The drop-down window 428 may utilize other suitable visual cues for indicating which of the technicians 102 is on the last job, according to further embodiments.

The skills column 442 indicates the skill set for the technician 102 identified by the technician ID column 430 and the technician name column 432. In one embodiment, when the technician 102 is on the last job, the skill set for the technician 102 may be amended to make the technician 102 eligible to receive more jobs. The LBS 106 may access an interface on the web browser 310, for example, to amend the skill set of the technician 102. In one embodiment the drop-down window 428 includes a terminate button 448 with which to close the drop-down window 428.

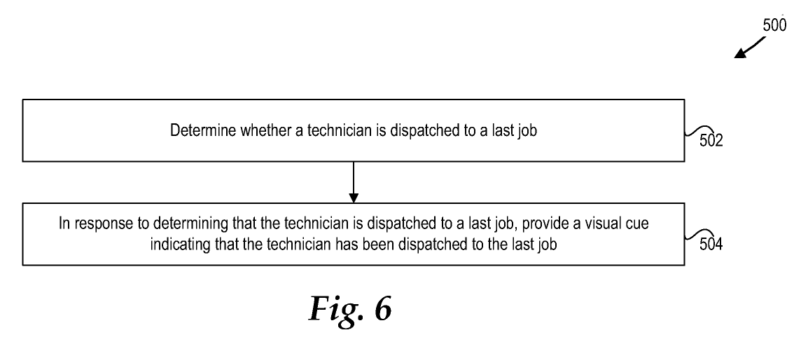

FIG. 6 is a flow diagram illustrating a method 500 for providing notification of a last job, in accordance with exemplary embodiments. According to the method 500, the NJA notification module 216 determines (at 502) whether a technician, such as the technicians 102, is dispatched on a last job. Whether the technician 102 is dispatched on a last job may be determined by viewing the work list (i.e., a schedule of jobs for a given time period, such as a day) of the technician 102. If the work list indicates that the technician 102 is scheduled for a next job after completing the currently dispatched job, then the technician 102 is not on a last job. If, however, the work list indicates that the technician 102 is not scheduled for a next job after completing the currently dispatched job, then the technician 102 is on a last job. In one embodiment, the work list is received from the data storage unit 114.

In response to determining that the technician 102 is dispatched to a last job, the NJA notification module 216 provides (at 504) a visual cue indicating that the technician 102 has been dispatched to a last job. In one embodiment, the reallocation module 112, which includes the NJA notification module 216, generates a GUI, such as the GUI 400. The GUI 400 may include a Dispatches column, such as the Dispatches column 420 for indicating the number of technicians 102 dispatched for a particular turf, such as the turfs 402, and a particular bucket, such as the buckets 406, 408, 410, 412, 414. Each cell under the Dispatches column 420, such as the cell 424, may be highlighted to specify that at least one of the technicians 102 dispatched for the particular turf 402 and the particular bucket 406, 408, 410, 412, 414 is on a last job.

In one embodiment, at least the highlighted cells, such as the cell 424, in the Dispatches column 420 may be accessed by an input device, such as the mouse 308. For example, a window, such as the drop-down window 428, may be accessed by hovering a mouse cursor over the cell 424 or by clicking the cell 424 using the mouse 308. The window may provide additional information with regards to the one or more technicians 102 on a last job. For example, the window may specify which technicians 102 are on a last job. With the information provided by the window, the LBS 106 may take action to prevent the technicians 102 on a last job from receiving a NJA message.

In one embodiment, the NJA notification module 216 provides the notification to the LBS 106 only if the technician 102 has at least a specified amount of available time, such as thirty minutes, left in the work shift of the technician 102. The amount of available time may be determined by subtracting an estimated completion time of the last job (i.e., the current job of the technician 102) from the amount of time left until the work shift of the technician 102 ends.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for providing a notification of a last job dispatch, comprising:
determining whether a technician is dispatched to a last job; and
in response to determining that the technician is dispatched to the last job, providing a visual cue indicating that the technician is dispatched to the last job.

2. The method of claim 1, wherein determining whether a technician is dispatched to a last job comprises:
retrieving a work list for the technician; and
determining, from the work list, whether a next job is scheduled after the technician completes a currently dispatched job.

3. The method of claim 2, wherein retrieving a work list for the technician comprises receiving the work list from an Integrated Dispatch System (IDS).

4. The method of claim 1, wherein providing a visual cue indicating that the technician is dispatched to the last job comprises providing the visual cue indicating that the technician is dispatched to the last job only if the technician has a given amount of available time.

5. The method of claim 4, further comprising:
determining the available time by subtracting an estimated amount of time to complete a currently dispatched job from an amount of time left in a work shift of the technician.

6. The method of claim 1, wherein providing a visual cue indicating that the technician is dispatched to the last job comprises highlighting a cell in a graphical user interface (GUI), the cell indicating a number of technicians that are dispatched.

7. The method of claim 6, further comprising:
accessing the cell to view a window, the window providing an identification of each technician that is dispatched.

8. A system for providing a notification of a last job dispatch, comprising
a memory for storing a program containing code for providing a notification of a last job dispatch;
a processor functionally coupled to the memory, the processor being responsive to computer-executable instructions contained in the program and operative to:
determine whether a technician is dispatched to a last job; and
in response to determining that the technician is dispatched to the last job, provide a visual cue indicating that the technician is dispatched to the last job.

9. The system of claim 8, wherein to determine whether the technician is dispatched to the last job, the processor is further operative to:
retrieve a work list for the technician; and
determine, from the work list, whether a next job is scheduled after the technician completes a currently dispatched job.

10. The system of claim 9, wherein the work list is retrieved from an Integrated Dispatch System (IDS).

11. The system of claim 8, wherein the visual cue is provided only if the technician has a given amount of available time.

12. The system of claim 11, wherein the processor is further operative to determine the available time by subtracting an estimated amount of time to complete a currently dispatched job from an amount of time left in a work shift of the technician.

13. The system of claim 8, wherein the visual cue is provided by highlighting a cell in a graphical user interface (GUI), the cell indicating a number of technicians that are dispatched.

14. A computer-readable medium having instructions stored thereon for execution by a processor to perform a method for providing a notification of a last job dispatch, the method comprising:
determining whether a technician is dispatched to a last job; and
in response to determining that the technician is dispatched to the last job, providing a visual cue indicating that the technician is dispatched to the last job.

15. The computer-readable medium of 14, wherein determining whether a technician is dispatched to a last job comprises:
retrieving a work list for the technician; and
determining, from the work list, whether a next job is scheduled after the technician completes a currently dispatched job.

16. The computer-readable medium of claim 15, wherein retrieving a work list for the technician comprises receiving the work list from an Integrated Dispatch System (IDS).

17. The computer-readable medium of claim 14, wherein providing a visual cue indicating that the technician is dispatched to the last job comprises providing the visual cue indicating that the technician is dispatched to the last job only if the technician has a given amount of available time.

18. The computer-readable medium of claim 17, the method further comprising:
determining the available time by subtracting an estimated amount of time to complete a currently dispatched job from an amount of time left in a work shift of the technician.

19. The computer-readable medium of claim 14, wherein providing a visual cue indicating that the technician is dispatched to the last job comprises highlighting a cell in a graphical user interface (GUI), the cell indicating a number of technicians that are dispatched.

20. The computer-readable medium of claim 19, the method further comprising:
accessing the cell to view a window, the window providing an identification of each technician that is dispatched.
